(19) United States
(12) Patent Application Publication
(10) Pub. No.: US 2012/0118160 A1
(43) Pub. Date: May 17, 2012

(54) Attrition resistant hardened zeolite materials for air filtration media

(76) Inventors: Ruth G. Heffes, Glen Burnie, MD (US); Fitzgerald A. Sinclair, Smyrna, DE (US); Michael C. Withiam, Landenberg, PA (US); Terry W. Nassivera, Bel Air, MD (US)

(21) Appl. No.: 11/823,263

(22) Filed: Jun. 27, 2007

(51) Int. Cl. B01D 53/02; B29C 47/00

(52) U.S. Cl. 96/153; 264/176.1

(57) ABSTRACT

Environmental control in air handling systems that are required to provide highly effective filtration of noxious gases particularly within filter canisters that are ultrasonically welded enclosures is provided. In one embodiment, a filtration system utilizes a novel zeolite material that has been hardened to withstand ultrasonic welding conditions in order to reduce the propensity of such a material to destabilize and/or dust. Such a hardened zeolite thus enables for trapping and removal of certain undesirable gases (such as ammonia, ethylene oxide, formaldehyde, and nitrous oxide, as examples) from an enclosed environment, particularly in combination with metal-doped silica gel materials. Such a hardened zeolite is acidic in nature and not reacted with any salts or like substances and, as it remains in a hardened state upon inclusion within a welded filter device, the filter medium itself permits proper throughput with little to no dusting, thereby providing proper utilization and reliability for such a gas removal purpose. Methods of using and the application within specific filter apparatuses are also encompassed within this invention.

### FIELD OF THE INVENTION

The present invention relates generally to environmental control in air handling systems that are required to provide highly effective filtration of noxious gases particularly within filter canisters that are ultrasonically welded enclosures. In one embodiment, a filtration system utilizes a novel zeolite material that has been hardened to withstand ultrasonic welding conditions in order to reduce the propensity of such a material to destabilize and/or dust. Such a hardened zeolite thus enables for trapping and removal of certain undesirable gases (such as ammonia, ethylene oxide, formaldehyde, and nitrous oxide, as examples) from an enclosed environment, particularly in combination with metal-doped silica gel materials. Such a hardened zeolite is acidic in nature and not reacted with any salts or like substances and, as it remains in a hardened state upon inclusion within a welded filter device, the filter medium itself permits proper throughput with little to no dusting, thereby providing proper utilization and reliability for such a gas removal purpose. Methods of using and the application within specific filter apparatuses are also encompassed within this invention.

### BACKGROUND OF THE INVENTION

There is an ever-increasing need for air handling systems that include air filtration systems that can protect an enclosure against noxious airborne vapors and particulates released in the vicinity of the enclosure. Every year there are numerous incidents of noxious vapors contaminating building environments and causing illness and disruptions. There is also a current effort to protect buildings and other significant enclosures against toxic airborne vapors and particulates being released as part of terrorist acts. As a result, new filter design requirements have been promoted by the United States government to protect against certain toxic gases. Whether in a civilian or military setting, a typical air filtration system that contains only a particulate filter (for example, a cardboard framed fiberglass matt filter) provides no protection at all against toxic vapors. Commercially available electrostatic fiber filters exhibit higher removal efficiencies for smaller particles than standard dust filters, but they have no vapor filtration capability. HEPA (“High-Efficiency Particulate Air”) filters are used for high-efficiency filtration of airborne dispersions of ultrafine solid and liquid particulates such as dust and pollen, radioactive particle contaminants, and aerosols. However, where the threat is a gaseous chemical compound or a gaseous particle of extremely small size (i.e., <0.001 microns), the conventional commercially-available HEPA filters cannot intercept and control those types of airborne agents.

Although carbon-based media are highly effective for many gases in terms of removal, other noxious vapors, such as ethylene oxide, cannot be removed from environments easily by such carbon-based materials (such as active carbon, and the like). It has been realized that zeolite, in particular the zeolite ZSM-5, makes an excellent gas filter media for ethylene oxide. However, such a zeolite material exhibits a high propensity for dusting and destabilization as a solid, particularly upon exposure to high energy, such as ultrasonification. As such, with too much small particle material in a filter, the throughput capability of such a filter medium is drastically reduced due to the dense packing of such small particles. A larger size is needed to prevent small particle generation and concomitant dusting problems in order to provide an acceptable gas filter medium in terms of such throughput issues. In situations where a filter article is subjected to high energy treatments, such as ultrasonic welding to seal an already-filled metal filter canister, for example, such a zeolite is liable to exhibit high attrition rates and thus an undesirable level of small particle generation. As such, little has been provided within the pertinent prior art that concerns the ability to provide uptake and breakthrough levels by such ZSM-5-containing filter media on a permanent basis and at levels that are acceptable for large-scale usage (in order to withstand high energy exposures). Uptake basically is a measure of the ability of the filter medium to capture a certain volume of the subject gas in a short period of time (fast mass transfer); breakthrough is an indication of the loss of usefulness of the filter medium (a combination of capture and filter medium equilibrium capacity). Thus, it is highly desirable to find a proper filter medium that exhibits a high uptake (and thus quick capture of large amounts of noxious gases) and long breakthrough times (and thus, coupled with uptake, the ability to not only effectuate quick capture but also extensive lengths of time to reach the filter capacity).

Ethylene oxide (“EO”) is a highly toxic substance found in various locations as a gas. Stringent governmental guidelines have been developed in an effort to protect workers present within a potentially EO-contaminated environment. As a result of its high toxicity, The US Department of Labor Occupational Safety and Health Administration (“OSHA”) has set stringent guidelines aimed at protecting workers performing operations in an environment potentially contaminated with ethylene oxide. The Permissible Exposure Limit (“PEL”) for ethylene oxide has been established at 1.8 mg/m³ (approximately 1 ppm). Therefore, effective means of removing ethylene oxide from ambient streams of air are needed.

H-ZSM-5 is known to be a highly efficient solid acid catalyst for the removal of ethylene oxide from ambient air streams. It does so by catalyzing the hydration of the epoxide ring, thus converting it into ethylene glycol which can then be adsorbed. In its standard form H-ZSM-5 is a dust comprised of irregular particles with diameters ranging from 2-5 μm in diameter, which results in unacceptably high pressure drops when used in filters. To reduce this pressure drop zeolites are typically granulated prior to their use, however as a result of their crystalline nature the resulting granules can be quite brittle. The closest art concerning the utilization of zeolites for ethylene oxide modification through dehydration of such a compound to different, harmless, or less harmful, species, is found within U.S. Pat. No. 4,306,106 to Kerr et al. The utilization of impregnated zeolites for EO removal from airstreams is disclosed within U.S. Pat. No. 6,837,917 to Karwacki et al. However, there is no discussion of the availability of such materials in a hardened state that permits high energy exposure, thereby providing a reliable EO filter medium in ultrasonically welded filter articles within either of these publications.

### BRIEF DESCRIPTION OF THE INVENTION

One distinct advantage of this invention is the provision of a filter medium that exhibits highly effective simultaneous ammonia and ethylene oxide breakthrough properties under conditions typical of an enclosed space and over a wide range of relative humidity. Among other advantages of this invention is the provision of a filter system for utilization within an enclosed space that exhibits a steady and effective uptake and breakthrough result for ammonia gas and that removes such noxious gases from an enclosed space at a suitable rate for reduction below critical levels for human exposure. Yet another advantage is the ability of this invention to irreversibly prevent release of noxious gases once adsorbed, under normal conditions. Furthermore, as noted above, such a combination exhibits the ability to capture nitrous oxide without further converting it to nitrogen oxide.

Accordingly, this invention encompasses a filter medium comprising a hardened ZSM-5-containing filter medium is provided including a binder material selected from the group consisting of bentonite, psedoboehmite, colloidal silica, and mixtures thereof. As well, a ZSM-5 filter medium produced via a mix spinning procedure or an extrusion procedure, including the same binder materials noted above. Also encompassed within this invention is an air filtration medium comprised of a hardened ZSM-5 material, wherein said air filtration medium exhibits an ethylene oxide breakthrough of at least 40 minutes when the challenge concentration of ethylene oxide is 1,000 mg/m³ at 25° C. and the breakthrough concentration of ethylene oxide is 1.8 mg/m³ at 25° C., and wherein said ZSM-5 material exhibits an attrition rate of at most 60% exposure to high energy treatment.

Also, said invention encompasses a filter system wherein at least 0.5% by weight of such a filter medium has been introduced therein. The amount may be as high as 100% by weight of the filter medium; however, the inclusion of other filtration materials, such as silica gels, metal-doped silica gels, oxidized silica materials, as well as carbon materials (such as the aforementioned ASZM-TEDA) (for removal of other noxious gaseous materials), is possible as well.

### DETAILED DESCRIPTION OF THE INVENTION

Crystalline zeolite granules require hardening for a variety of applications. Previous artwork included fluidized bed granulation or spray dryer granulation of the zeolite binder mixture followed by a calcination step for the setting of the binder. This invention uses a high shear granulation (wet granulation) process with combinations of three different binder systems to produce granules that are attrition resistant from vibratory and compression forces.

The present invention thus relates to the creation of hardened zeolite spherical granules produced in a high shear granulator or via an extrusion process without a post granule formation heat treatment step. Four binder systems demonstrated improvement in attrition resistance: 1) bentonite and colloidal silica (such as LUDOX® LS from Grace-Davison, as one example); 2) bentonite alone; 3) pseudoboehmite (such as CATAPAL® from Sasol, as one example) with Nitric Acid and 3) pseudoboehmite with nitric acid and bentonite. The materials were oven dried at low temperatures, such as from 85 to 115° C., to achieve target moistures of less than 10%, with no subsequent high temperature (or calcination) treatment thereafter. One application of the present invention in certain forms has demonstrated to provide an absorbent material suitable for the removal of ethylene oxide and/or ammonia and/or formaldehyde from streams of air using a composite material containing a copper impregnated gel silica and a zeolite, all without exhibiting too great a disintegration (attrition) rate into small particles upon exposure to high energy treatments (such as ultrasonic welding, for instance).

The present invention includes a process in which all components in the dry powder stage are mixed in a high shear granulator, without the addition of water. Once homogenous, all liquid components are added to the granulator with the granulator container (such as a mixing vessel or bowl) and rotor spinning. Granules can be formed with more water (top down) or less water (bottom up) formation. Granule size is modified by balancing the quantity of water added and the residence time in the mixing container. Lower moisture measurements and higher spin times result in smaller granules. Batches of any of the above mentioned binder systems are generally targeted to exhibit 28 to 38% batch moisture at the start of the granulation step. Once completed, the resultant granule moisture is generally from about 20 to 25%, then ultimately was reduced to at most 10% via the aforementioned low temperature (85-115° C.) oven drying step. In another potentially preferred method, granules may also be formed as extrudates by blending the zeolite plus binders in a high shear mixing vessel (such as an Eirich or Simpson Mix-Muller), spinning briefly (for about 10 to 20 minutes at the unit's high speed setting), and then feeding to an extruder having an aperture die plate with circular opening of 1/16″ and a mid-range feed screw.

Granule hardness was measured using a modified method based on ASTM: D 3802-79. Hardness was also verified using an internally developed test measuring particle to particle attrition whereas the ASTM test measures more the compression strength of the particles.

Attrition resistance was achieved using a binder system selected from the following: 1) bentonite (with water), 2) bentonite and colloidal silica, 3) pseudoboehmite with nitric acid, and 4) pseudoboehmite with nitric acid and bentonite.

The zeolite component is not required to be impregnated or reacted with any other compounds in order to be effective and thus is preferably in acid form (referred to as the hydrogen form or alternatively, H-ZSM-5) during utilization within the process of this invention. Impregnation or treatment of the zeolite with oxidizer does afford additional protections against the reduction of NO₂ to other species like NO, however. The preferred zeolite of the present invention, H-ZSM-5, may be purchased from commercial sources, such as Zeolyst or UOP. Alternatively, H-ZSM-5 may be synthesized using techniques known to one skilled in the art and discussed, as one example, within U.S. Pat. No. 3,702,886. ZSM-5 is a high silica zeolite consisting of a series of interconnecting parallel and sinusoidal channels approximately 5.8 A in diameter (Szostak, Molecular Sieves: Principles of Synthesis and Identification, 1989, p. 14, 23-25). ZSM-5 is also a member of the pentisil family of zeolites which includes zeolitic materials whose structure consists of 5-membered rings and include other compounds known within the industry as ZSM-8 and ZSM-11, as non-limiting examples. Such pentisil zeolites are thus potentially preferred compounds within this inventive combination filter medium as well. Again, it is a potentially preferred embodiment that the zeolite component be treated similarly in terms of oxidizing agents as for the gel materials noted previously.

ZSM-5 can be prepared with a range of SiO₂/Al₂O₃ ratios, from greater than or equal to about 10,000 to less than or equal to about 20. Because of its high silica content and small pores, ZSM-5 is hydrophobic, adsorbing a relatively small amount of water under high RH conditions. As synthesized and subsequent to ion exchange, ZSM-5 exists as small crystals. According to various embodiments of the present invention, the zeolite may be configured in any form, such as particles, rings, cylinders, spheres, and the like. Alternatively, the zeolite, e.g., H-ZSM-5, may be configured as a monolith, or coated onto the walls of a ceramic material, such as for example honeycomb corderite. Failure to configure the zeolite (e.g., H-ZSM-5 crystals) as described above will result in excessive pressure drop across the filtration media. Configuring the zeolite, preferably H-ZSM-5 crystals, into various geometrical shapes can be performed using operations well known to one skilled in the art, such as such varied techniques as include prilling, extruding, and the like. As noted above, a certain binder system, as well as certain binder application methods, are necessary for the specific inventive hardened zeolite material to function properly.

H-ZSM-5, a crystalline zeolite, was bound with a combination of bentonite clay, pseudobohemite, colloidal silica and acid. These binders are compatible with strong oxidizers that may be added to the zeolite for additional chemical performance and will stand up to the harsh effects of such actives. These binders are stable at elevated temperatures and with strong oxidizers, something not possible with traditional organic binder systems involving HPC, EC, HPMC, Acacia Gum, etc.

The present invention, according to one embodiment, comprises the formation of robust adsorbent granules for removing ethylene oxide from air over a wide range of ambient temperatures and relative humidity conditions. Said process comprises the granulation of H-ZSM-5 under ambient conditions using a HNO₃/inorganic binder system in a high shear granulation method (Eirich Mixer), which does not requires a heating temperature exceeding 200° C. for post-treatment to yield sufficient hardness. The general process produces spherical granules that require heating at 85° C. to drive off moisture to 6-10%. No calcining or high temperature heat treatment is required for attrition resistance, thus providing an efficient method of generating such highly desirable hardened zeolite materials.

The hardened zeolite materials are thus generally produced through the following alternative methods. In a first potential embodiment, a zeolite, preferably ZSM-5 is first acidified with nitric acid (in an amount of 6% dry weight to weight of dry zeolite), to which from 1-10% by weight of bentonite is added either alone or together with pseudoboehmite (in a like amount). Water is then added to this physical mixture of dry ingredients and the resultant product is spin mixed (such as in an Eirich mixer) to form fine spherical granules (for approximately 20-60 minutes). The resultant granules are then dried in an oven at a temperature of from 85-150° C. until the moisture level is below about 10% thereof. In a second potential embodiment, the zeolite is first physically mixed with bentonite (in like amounts above) to which either acid or water is then added (in an amount of about of 30-35% total batch moisture). To this mixture is then added either colloidal silica (Ludox) or pseudoboehmite (Catapal) in an amount of from about 1 to 10% by weight of the physical mixture. Again, the resultant mixture is spin mixed to form fine granules and dried, both just as described above. One further potential embodiment includes the initial mixing of the zeolite with pseudoboehmite with water or acid then added (all in amounts as noted above), with an optional addition of bentonite thereafter, with the same spin mixing and drying steps followed as well. These methods may also be employed with an extrusion step (such as utilizing a Bonnot extruder, as one example, having various die sizes, such as 1/16″) instead of or in addition to the spin mixing step noted above. Such extrusion may in fact be preferred to provide improved hardness results thereof.

According to another embodiment, the present invention comprises a process for the removal of EO, ammonia, nitrogen oxide, and/or formaldehyde from air over a wide range of ambient temperatures and relative humidity conditions, said process comprising contacting the air within an ultrasonically welded filter with the inventive hardened zeolite materials, as well as other optional materials, such as metal-doped silicon gel-based materials, for a sufficient time period to remove ethylene oxide, at least, as well as possibly ammonia, nitrous oxide, and/or formaldehyde. Without intending to be limited to any specific scientific theory, it is believed that the EO gas is removed from the ambient air stream via adsorption of EO into the pores of the zeolite followed by chemical reaction, not limited to but including hydrolysis to form various glycols. As for the other subject gases, it is believed, again without any specific scientific theory, that ammonia, nitrous oxide, and formaldehyde gases are removed through the adsorption of gas within the pores of the materials involved and subsequent capture by the metal dopant present therein.

The contact time between the filter medium and the noxious gas(es) and the ambient air stream being treated can vary greatly depending on the nature of the application, such as, for example, the desired filtration capacity, flow rates and concentration of EO in the ambient air stream. However, in order to achieve a threshold level of EO removal, the contact time (e.g., bed depth divided by the superficial linear velocity) should be greater than about 0.05 seconds. A contact time of greater than 0.1 seconds is preferred for most applications, and a contact time of greater than 0.4 seconds is even more preferred for applications involving high concentrations of EO, or for applications where it is desired to achieve a high EO capacity in, e.g., a filter bed.

The filtration device employing the novel combination of materials may be of any shape and/or geometric form depending upon the desired application, as long as the filtration device promotes contact between the stream being treated and the filter medium itself. The removal efficiency of the noxious gas contaminated air stream passes through the filter medium will be a function of many parameters, such as, for example, the bed depth, the ambient concentration of noxious gas, relative humidity, flow rate, and the like. Examples of filtration devices which may utilize the present invention include but are not limited to, for example, gas mask canisters, respirators, filter banks such as those employed in fume hoods, ventilation systems, and the like. A blower motor, fan, etc. may be used as a means of forcing ambient air through the device, if desired.

The hardened zeolites are employed in the filter medium of this invention in an amount from about 1 to about 90 percent, preferably about 5 to about 70 percent, by weight of the entire filter medium composition. If in combination with another material, such as a metal-doped silicon-based gel material or carbon-based compound, preferably, the zeolite is present in a any amount, though preferably as the major amount (greater than 50%) of the combination.

The filter medium of the invention can also further contain as optional ingredients, silicates, clays, talcs, aluminas, carbons, polymers, including but not limited to polysaccharides, gums or other substances used as binder fillers. These are conventional components of filter media, and materials suitable for this purpose need not be enumerated for they are well known to those skilled in the art. Furthermore, such metal-doped silicon-based gels of the invention may also be introduced within a polymer composition (through impregnation, or through extrusion) to provide a polymeric film, composite, or other type of polymeric solid for utilization as a filter medium. Additionally, a nonwoven fabric may be impregnated, coated, or otherwise treated with such invention materials, or individual yarns or filaments may be extruded with such materials and formed into a nonwoven, woven, or knit web, all to provide a filter medium base as well. Additionally, the inventive filter media may be layered within a filter canister with other types of filter media present therewith (such as layers of activated carbon, or, alternatively, the filter media may be interspersed together within the same canister. Such films and/or fabrics, as noted above, may include discrete areas of filter medium, or the same type of interspersed materials (activated carbon mixed on the surface, or co-extruded, as merely examples, within the same fabric or film) as well.

The filter system utilized for testing of the viability of the medium typically contains a media bed thickness of from about 1 cm to about 3 cm thickness, preferably about 1 cm to about 2 cm thickness within a 4.1-cm diameter tube. Without limitation, typical filters that may actually include such a filter medium, for example, for industrial and/or personal use, will comprise greater thicknesses (and thus amounts) of such a filter medium, from about 1-15 cm in thickness and approximately 10 cm in diameter, for example for personal canister filter types, up to 400 cm in thickness and 200 cm in diameter, at least, for industrial uses. Again, these are only intended to be rough approximations for such end use applications; any thickness, diameter, width, height, etc., of the bed and/or the container may be utilized in actuality, depending on the length of time the filter may be in use and the potential for gaseous contamination the target environment may exhibit. Any amount of filter medium may be introduced within a filter system, as long as the container is structurally sufficient to hold the filter medium therein and permits proper airflow in order for the filter medium to properly contact the target gases.

It is important to note that although EO is the main test subject gas for removal by the inventive filter media discussed herein, such media may also be effective in removing other noxious gases from certain environments as well, including ammonia, nitrogen oxides, formaldehyde and methylamine, as merely examples, particularly if the medium includes other materials, as noted above.

As previously mentioned, the filter medium can be used in filtration applications in an industrial setting (such as protecting entire industrial buildings or individual workers, via masks), a military setting (such as filters for vehicles or buildings or masks for individual troops), commercial/public settings (office buildings, shopping centers, museums, governmental locations and installations, and the like), and personal settings (such as homes, vehicles, etc., with large filters or personal gas masks). Specific examples may include, without limitation, the protection of workers in agricultural environments, such as within poultry houses, as one example, where vast quantities of ammonia gas can be generated by animal waste. Thus, large-scale filters may be utilized in such locations, or individuals may utilize personal filter apparatuses for such purposes. Furthermore, such filters may be utilized at or around transformers that may generate certain noxious gases. Generally, such inventive filter media may be included in any type of filter system that is necessary and useful for the removal of potential noxious gases in any type of environment.

### PREFERRED EMBODIMENTS OF THE INVENTION

### Test Materials

### Comparative Example 1

Particles of commercially available ASZM TEDA carbon available from Calgon Incorporated, were sized by sieving to recover particles sized between 1000 μm and 425 μm.

### Comparative Example 2

Particles of commercially available sodium ZSM5 zeolite available from Zeolyst Incorporated, were procured.

### Comparative Example 3

A sample of the zeolite from Comparative Example 2, above, was converted to the acid form. 200 g Zeolyst powder was dispersed in 1000 g deionized water. To this suspension was added 80 g ammonium nitrate and the mixture stirred for 2 hours before being filtered and washed. The recovered wet solids were again dispersed in 1000 g deionized water with 40 g ammonium nitrate and again stirred for 2 hours. The solids were filtered and washed before being dried for 16 hr at 105° C. The dry exchanged zeolite was then calcined at 550° C. for 2 hours to yield the acid H-ZSM5.

### Comparative Example 4

### Doped Silica Gel Material

900 liters of water was introduced into a filter feed tank. The pH thereof was adjusted to 4 with 11.4% sulfuric acid and the resultant solution was then heated to 90° C. using steam sparging. The feed tank was then filled completely with cold water and cooled to about 30° C.

In a 400 gallon reactor, 150 liters of room temperature sulfuric (11.4 wt %) acid was introduced under sufficient agitation to stir, but with minimal splashing. Sodium silicate addition (3.3 molar ratio, 24.7 wt %) was then started at room temperature in two stages. The rate of silicate addition in the first stage was 3 liters/min until the pH level was about 2.5. The second stage of silicate addition then began at a rate of 1.5 liters/min until a pH of about 2.85 was reached. The silicate addition then stopped and the pH of the resultant batch was manually adjusted to 3.00.

The reactor batch was then pumped into the filter feed tank at a maintained temperature of about 90° C. without any agitation initially. After 22 minutes, the batch in the feed tank was agitated once for 1 minute, and again at the 44 minute point for 1 minute (both at 500 rpm). Immediately after the second agitation, the resultant gel slurry was washed and filtered with a filter press (EIMCO) until the filtrate conductivity was below 3000 μmho. The resultant product was then air purged for 10 minutes.

1000 g of the resultant dewatered silicic acid gel (17.2 wt % solids) was then weighed. To this gel was then added 258 g of copper sulfate pentahydrate and 150 mls of water. Under extremely high shear conditions (5000 rpm) (premier mill), 17.19 g of potassium permanganate crystals (the equivalent of 4% in the final dried composite) were then introduced. This formulation was then mixed for 30 minutes after which the resultant slurry was oven dried at 80° C. to a final moisture of 20-30% solids. The resultant particles were then compacted into granules at 7 mPa and which were then screened to 20×40 mesh.

### Comparative Example 5

This material was an 80:20 by volume blend consisting of 20×40 granules of ZSM5 (ZEOLYST® 3020E) based media with 6% weight HNO₃ and the silica material of Comparative Example 4.

### Comparative Example 6

To 7.344 lbs of ZSM5 (ZEOLYST® 3020E), 0.624 lbs of 68-70% HNO₃ diluted in 1.656 lbs of de-ionized water was then added. After all the acidified water was added, another 1.656 lbs of de-ionized water was added to the spinning mixture. The mixture was spun on high rotor and bowl speed until fine granules were formed. The mixture was then dried in an oven at 85 to 150° C. until a final moisture of <10% was reached.

### Inventive Materials

### Example 1

6.768 lbs of ZSM5 (Zeolyst 3020E) was mixed on low speeds with 0.384 lbs of bentonite, until well mixed (less than 5 minutes at less than 1.75 amps). To the dry ingredients was then added 0.576 lbs of 68-70% HNO₃ diluted in 1.8 lbs of de-ionized water. After all the acidified water was added, another 1.8 lbs of de-ionized water was added to the spinning mixture. The mixture was spun on high rotor and bowl speed until fine granules were formed (for approximately 40 minutes amp draws of approximately 2.0 rising to 2.5 after granule formation). The mixture was then dried in an oven at 85 to 150° C. until final moisture of <10% was reached.

### Example 2

7.02 lbs of ZSM5 (Zeolyst 3020E) and 0.528 lbs of bentonite were mixed on low speed until well mixed (less than 5 minutes at less than 1.75 amps). To the dry ingredients were added 0.6 lbs of 68-70% HNO₃ diluted in 1.93 lbs of de-ionized water. After all acidified water was added, another 1.93 lbs of de-ionized water was added to the spinning mixture. The mixture was spun on high rotor and bowl speed until fine granules were formed (for approximately 40 minutes). The mixture was then dried in an oven at 85 to 150° C. until a final moisture of <10% was reached.

### Example 3

6.504 lbs of ZSM5 (Zeolyst 3020E) and 0.78 lbs of bentonite was mixed on low speeds until well mixed (less than 5 minutes at less than 1.75 amps). To the dry ingredients add 0.552 lbs of 68-70% HNO₃ diluted in 2 lbs of de-ionized water. After all acidified water was added, another 2 lbs of de-ionized water was added to the spinning mixture. The mixture was spun on high rotor and bowl speed until fine granules were formed (for approximately 40 minutes). The mixture was then dried in an oven at 85 to 150° C. until final moisture of <10% was reached.

### Example 4

7.2 lbs of ZSM5 (Zeolyst 3020E) and 0.12 lbs bentonite and 0.12 lbs of pseudoboehmite was mixed on low speeds using an Eirich RV02 until well mixed (less than 5 minutes at less than 1.75 amps). To the dry ingredients were added 0.612 lbs of 68-70% HNO₃ diluted in 1.98 lbs of de-ionized water. After all acidified water was added, another 1.98 lbs of de-ionized water was added to the spinning mixture. The mixture was spun on high rotor and bowl speed until fine granules were formed (for approximately 40 minutes). The mixture was then dried in an oven at 85 to 150° C. until a final moisture of <10% was reached.

### Example 5

This material was an 80:20 by volume blend consisting of 25×40 granules of the material of Example 1 and the silica gel material of Comparative Example 4.

### Example 6

This material was an 80:20 by volume blend consisting of 25×40 granules of the material of Example 2 and the silica gel material of Comparative Example 4.

### Example 7

This material was an 80:20 by volume blend consisting of 20×40 granules of the material of Example 3 and the silica gel material of Comparative Example 4.

### Example 8

This material was an 80:20 by volume blend consisting of 20×40 granules of the material of Example 4 and the silica gel material of Comparative Example 4.

### Example 9

4.87 lbs of ZSM5 (Zeolyst 3020E) and 1.5 lbs bentonite were mixed at low speeds was mixed on low speeds using an Eirich RV02 until well mixed (less than 5 minutes at less than 1.75 amps). To the dry ingredients was added 0.33 lbs Ludox® LS (30% Solids)(colloidal silica) diluted in 3.3 lbs of de-ionized water. The mixture was spun on high rotor and bowl speed until fine granules were formed (for approximately 80 minutes). The mixture was then dried in an oven at 85 to 150° C. until final moisture of <10% was reached.

### Example 10

5.2 lbs of ZSM5 (Zeolyst 3020E) and 1.5 lbs bentonite were mixed at low speeds was mixed on low speeds using an Eirich RV02 until well mixed (less than 5 minutes at less than 1.75 amps). To the dry ingredients 3.3 lbs of de-ionized water was then added and the mixture was then spun in an Eirich mixer. The mixture was spun on high rotor and bowl speed until fine granules were formed (for approximately 60 minutes). The mixture was then dried in an oven at 85 to 150° C. until final moisture of <10% was reached.

### Example 11

5.03 lbs of ZSM5 (Zeolyst 3020E) and 0.98 lbs bentonite were mixed at low speeds was mixed on low speeds using an Eirich RV02 until well mixed (less than 5 minutes at less than 1.75 amps). To the dry ingredients was added 2.33 lbs Ludox LS (30% Solids) diluted in 1.67 lbs of de-ionized water and the mixture was then spun in an Eirich mixer. The mixture was spun on high rotor and bowl speed until fine granules were formed (for approximately 40 minutes). The mixture was then dried in an oven at 85 to 150° C. until final moisture of <10% was reached.

### Example 12

6.38 lbs of ZSM5 (Zeolyst 3020E) and 0.384 lbs bentonite and 0.384 lbs Catapal® (pseudobohemite) were mixed at low speeds was mixed on low speeds using an Eirich RV02 until well mixed (less than 5 minutes at less than 1.75 amps). To the dry ingredients was added 0.54 lbs of 68-70% HNO₃ diluted in 2.15 lbs of de-ionized water, with the mixer bowl and rotor set to high speed. After all acidified water was added, another 2.15 lbs of de-ionized water was added to the spinning mixture. The mixture was spun on high rotor and bowl speed until fine granules were formed (for approximately 40 minutes). The mixture was then dried in an oven at 85 to 150° C. until a final moisture of <10% was reached.

### Example 13

5.03 lbs of ZSM5 (Zeolyst 3020E) and 0.63 lbs bentonite and 0.63 lbs Catapal (pseudobohemite) were mixed at low speeds was mixed on low speeds using an Eirich RV02 until well mixed (less than 5 minutes at less than 1.75 amps). To the dry ingredients was added 0.06 lbs of 68-70% HNO₃ diluted in 2.3 lbs of de-ionized water, with the mixer bowl and rotor set to high. After all acidified water was added, another 1.3 lbs of de-ionized water was added to the spinning mixture. The mixture was spun on high rotor and bowl speed until fine granules were formed (for approximately 40 minutes). The mixture was then dried in an oven at 85 to 150° C. until a final moisture of <10% was reached.

### Example 14

5.64 lbs of ZSM5 (Zeolyst 3020E) and 1.0 lb Catapal (pseudobohemite) were mixed at low speeds was mixed on low speeds using an Eirich RV02 until well mixed (less than 5 minutes at less than 1.75 amps). To the dry ingredients was added 2.2 lbs of de-ionized water and 0.06 lbs of 68-70% HNO₃ in 0.3 lbs of de-ionized water, and slowly added to the spinning mixer. The mixture was spun on high rotor and bowl speed until fine granules were formed, and thereafter the acidic water remainder was then added. The mixture was then dried in an oven at 85 to 150° C. until a final moisture of <10% was reached.

### Example 15

5.25 lbs of ZSM5 (Zeolyst 3020E) and 1.6 lb Catapal (pseudobohemite) were mixed at low speeds was mixed on low speeds using an Eirich RV02 until well mixed (less than 5 minutes at less than 1.75 amps). To the dry ingredients was added 1.6 lbs of water and 0.098 lbs of 68-70% HNO₃ in 0.41 lbs of de-ionized water, and slowly added to the spinning mixer. The mixture was spun on high rotor and bowl speed until fine granules were formed, and thereafter the acidic water remainder was then added. The mixture was then dried in an oven at 85 to 150° C. until a final moisture of <10% was reached.

### Example 16

### Extrusion

6.38 lbs of ZSM5 (Zeolyst 3020E) and 0.384 lbs Bentonite and 0.384 lbs Catapal (pseudobohemite) were mixed at low speeds using an Eirich RV02 until well mixed (less than 5 minutes at less than 1.75 amps). To the dry ingredients was added 0.54 lbs of 68-70% HNO₃ diluted in 2.15 lbs of de-ionized water, with the mixer bowl and rotor set to high. After all acidified water was added to get the batch moisture to 31%. The resultant mixture was then fed to a 2″ Bonnot extruder with a 1/16″ die plate. The extrudates were oven dried at 85 to 150° C. until a final moisture of <10% was reached. The extrudates were sized on an Alexanderwerks rotary fine granulator.

### EO Filtration Testing

Ethylene oxide removal is carried out via contacting the contaminated air with said zeolite granules alone or as part of a composite matrix for a sufficient time that the acid catalyzed hydrolysis to ethylene glycol can occur. The robustness of these granules can be increased further by increasing the binder loading or by using a mixed binder system, however these changes are accompanied by a loss in EtOx EO performance.

These initially made examples were thus then tested EO breakthrough. The general protocol utilized for breakthrough measurements involved the use of two parallel flow systems having two distinct valves leading to two distinct absorbent beds (including the filter medium), connected to two different infrared detectors, followed by two mass flow controllers and then a vacuum source. The overall system basically permitting mixing of EO, air, and water vapor within the same pipeline for transfer to either adsorbent bed with some excess vented to a filtration system. In such a manner, the uptake of the filter media within the two absorbent beds was compared for ammonia concentration after a certain period of time through the analysis via the infrared detector as compared with the non-filtered ammonia/air mixture produced simultaneously. A vacuum was utilized at the end of the system to force the ammonia/air mixture through the two parallel flow systems as well as the non-filtered pipeline with the flow controlled using 0-50 SLPM mass flow controllers.

To generate the EO/air mixture, two mass flow controllers generated challenge concentration of test gas, one being a challenge air mass flow controller having a 0-100 SLPM range and the other being an ammonia mass flow controller having a 0-100 sccm range. A third air flow controller, was used to control the flow through a heated water sparger to maintain the desired challenge air relative humidity (RH). Two dew point analyzers, one located in the challenge air line above the beds and the other measuring the effluent RH coming out of one of the two filter beds, were utilized to determine the RH thereof (modified for different levels).

The beds were 4.1 cm glass tubes with a baffled screen to hold the adsorbent. The adsorbent was introduced into the glass tube using a fill tower to obtain the best and most uniform packing each time. The challenge chemical concentration was then measured using a HP 5890 gas chromatograph with a FID. The adsorbent was prepared for testing by screening all of the particles below 40 mesh (0.425 mm in diameter). The largest particles were typically no larger than a 20 mesh (0.85 mm in diameter).

The valves above the two beds were initially closed. The diluent air flow and the water sparger air flow were started and the system was allowed to equilibrate at the desired temperature and RH. The valves above the beds were then changed and simultaneously the chemical flow was started at a rate of 4.75 SLPM. The chemical flow was set to achieve the desired challenge chemical concentration. The effluent concentrations from the two absorbent beds (filter media) were measured continuously using the previously calibrated infrared spectroscopes. The breakthrough time was defined as the time when the effluent chemical concentration equals the target breakthrough concentration. For these ethylene oxide tests, the challenge concentration was 1,000 mg/m³ at 25° C. and the breakthrough concentration was 1.8 mg/m³ at 25° C.

EO breakthrough was then measured for distinct filter medium samples, with the fixed bed depth of 1 cm such samples modified as noted, the relative humidity adjusted, and the flow units of the test gas changed to determine the effectiveness of the filter medium under different conditions.

Attrition testing was measured by a modified method based on ASTM: D 3802-79, wherein the test method was modified to shorten the amount of time needed (to 6 minutes+/−30 seconds) and lessen the amount of sample needed (to 20 ml). A known volume of sample is taken. The weight of each test sample was recorded and each subject sample was placed in an ASTM Hardness Test Pan with steel balls. Each sample was shaken in the Hardness pan and then sieved through a nominal size screen. The fines were captured and weighed and the calculation was the weight of the fines divided by the total sample size and multiplied by 100 and reported as the % Attrition.

The results for EO breakthrough and attrition of the hardened zeolite are tabulated below (in the first table, both breakthrough and attrition were measured; in the second, just attrition measurements were taken)(the control sample was ZSM-5 zeolite alone without binder or acid):

TABLE 1
Breakthrough and Hardness Data

| | | EO Breakthrough Time |
|---|---|---|
| Example | % Attrition of Zeolite | at 80% RH (minutes) |
| Control | — | 0 |
| Comp. 3 | 56 | 60 |
| Comp. 4 | — | 0 |
| Comp. 5 | 59 | 61 |
| 5 | 44 | 58 |
| 6 | 42 | 49 |
| 7 | — | 20 |
| 8 | 41 | 25 |

TABLE 2
Hardness Data

| Example | % Attrition of Zeolite |
|---|---|
| 9 | 10 |
| 10 | 25 |
| 11 | 30 |
| 12 | 28 |
| 13 | 28 |
| 14 | 51 |
| 15 | 54 |
| 16 | 33 |

Furthermore, Comparative Example 3 exhibited instantaneous breakthrough and conversion of NO2 to NO; Comparative Example 5 exhibited 30 minutes breakthrough and conversion; and Inventive Example 5 exhibited 31 minutes for the same test. Thus, the improved attrition resistant material provided as effective breakthrough results with much better attrition properties.

Thus, the inventive hardened ZSM-5 materials exhibits not only excellent EO breakthrough times, but exhibited excellent attrition results, thereby permitting an optimized ability to withstand high energy treatments during packing and/or use and/or storage, as well as highly desirable filter capacity levels simultaneously.

While the invention was described and disclosed in connection with certain preferred embodiments and practices, it is in no way intended to limit the invention to those specific embodiments, rather it is intended to cover equivalent structures structural equivalents and all alternative embodiments and modifications as may be defined by the scope of the appended claims and equivalents thereto.

What we claim is:

1. A filter medium comprising a hardened ZSM-5-containing filter medium comprising a binder material selected from the group consisting of bentonite, psedoboehmite, colloidal silica, and mixtures thereof.

2. A ZSM-5 filter medium produced via a mix spinning procedure or an extrusion procedure, including the same binder materials noted above.

3. An air filtration medium comprised of a hardened ZSM-5 material, wherein said air filtration medium exhibits an ethylene oxide breakthrough of at least 40 minutes when the challenge concentration of ethylene oxide is 1,000 mg/m³ at 25° C. and the breakthrough concentration of ethylene oxide is 1.8 mg/m³ at 25° C., and wherein said ZSM-5 material exhibits an attrition rate of at most 60% upon exposure to high energy treatment.
